(19) United States
(12) Patent Application Publication
(10) Pub. No.: US 2026/0340588 A1
(43) Pub. Date: Oct. 29, 2026

(54) GRAPHICAL USER INTERFACE FOR SIGNOFF OF LAB PROCEDURES PERFORMED BY A ROBOTIC LAB

(71) Applicant: Artificial, Inc., Palo Alto, CA (US)

(72) Inventors: Paul Mandel, San Francisco, CA (US); Charles E. Crain, Austin, TX (US); James Juhasz, Laconia, NH (US); Michael S. Watson, Austin, TX (US); Daren K. Wilson, Austin, TX (US)

(21) Appl. No.: 19/190,513

(22) Filed: Apr. 25, 2025

(51) Int. Cl. G06Q 10/10

(52) U.S. Cl. CPC G06Q 10/103

(57) ABSTRACT

A system captures authenticated signatures for signoff of completed lab procedures performed by a robotic lab. The system accesses a set of lab procedures in performance by the robotic lab. The system identifies a first lab procedure needing signoff by an authorized user from a pre-approved list. The system transmits a notification to computing devices indicating completion of the first lab procedure and prompting signoff of the first lab procedure. The system receives a connection request by a computing device including login information identifying a first user. The system authenticates the connection request by evaluating whether the first user is in the pre-approved list. The system, in response to the authentication, generates, on the computing device associated with the first user, a graphical user interface displaying an option for inputting a signature. The system captures, via the option, the signature of the first user indicating signoff for the first lab procedure.

### BACKGROUND

In traditional lab environments, human operators work throughout the lab to perform one or more procedures (i.e., protocols) with equipment and reagents. For example, a human operator may mix reagents together, manually transport equipment from one benchtop to another, or operate a pipettor to handle liquids. In some instances, a lab environment may include one or more robots for performing different tasks in the lab environment. Ordinarily, a human in the workflow provides direct oversight into the quality assurance and control.

### SUMMARY

The following disclosure describes a lab automation system that performs procedures (i.e., laboratory protocols) in a robotic lab. The system for autonomously operating a lab implements controllable robots to perform a protocol in the lab environment. The system captures authenticated signatures for signoff of completed lab procedures. The system accesses a set of lab procedures in performance by the robotic lab. The system identifies a first lab procedure needing signoff by an authorized user from a pre-approved list. The system transmits a notification to computing devices indicating completion of the first lab procedure and prompting signoff of the first lab procedure. The system receives a connection request by a computing device including login information identifying a first user. The system authenticates the connection request by evaluating whether the first user is in the pre-approved list. The system, in response to the authentication, generates, on the computing device associated with the first user, a graphical user interface displaying an option for inputting a signature. The system captures, via the option, the signature of the first user indicating signoff for the first lab procedure.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 illustrates a system environment for a lab automation system, according to one or more embodiments.

FIG. 2A illustrates components of a lab, according to one or more embodiments.

FIG. 2B illustrates an example robot configured to perform procedures in a lab according to one or more embodiments.

FIG. 2C illustrates an example lab, according to one or more embodiments.

FIG. 3 illustrates a high-level block diagram of the lab automation system, according to one or more embodiments.

FIG. 4 illustrates a graphic user interface for the lab automation system, according to one or more embodiments.

FIG. 5 illustrates a flowchart of a signature authentication workflow implemented in an automated lab environment, according to one or more embodiments.

FIG. 6 is a process flowchart describing steps in signature authentication by a lab automation system, according to one or more embodiments.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

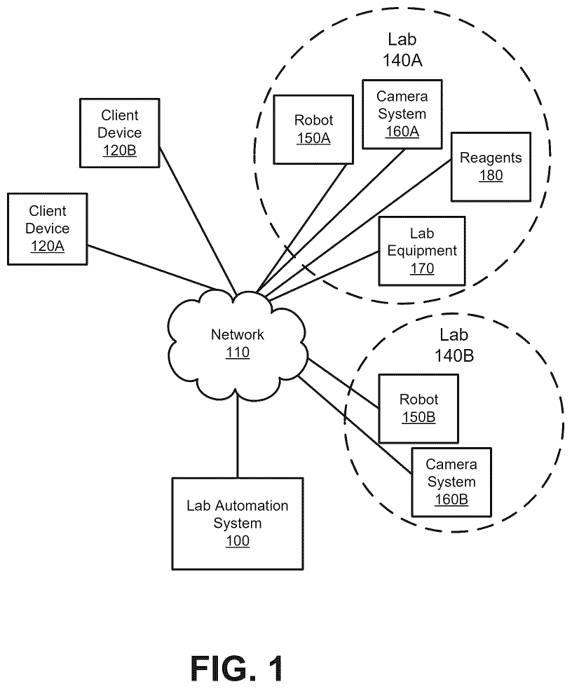

FIG. 1 illustrates a system environment for a lab automation system 100, according to one or more embodiments. The lab automation system 100 is connected to a number of client devices 120 used by operators of one or more labs 140 via a network 110. These various elements are now described in additional detail.

The client devices 120 are computing devices such as smart phones, laptop computers, desktop computers, or any other device that can communicate with the lab automation system 100 via the network 110. The client devices 120 may provide a number of applications, which may require user authentication before a user can use the applications, and the client devices 120 may interact with the lab automation system 100 via an application. For example, the client device 120 may require each user to sign on using a dedicated login, which may further be secured with multi-factor authentication. Multi-factor authentication may include any form of authentication. For example, one form of authentication includes pushing a passcode or key to a secure channel in use by the user (e.g., another computing device, an email account, a mobile phone, etc.). Another form of authentication may include face scanning, fingerprinting, voice identification, etc. The client devices may present graphic user interfaces displaying information transmitted from the lab automation system 100. Though two client devices 120 are shown in FIG. 1, any number of client devices 120 may be connected to the lab automation system 100 in other embodiments. The client devices 120 may be located within labs 140 connected to the lab automation system 100 or external to the labs. The client devices 120 may present graphic user interfaces for the drawing and visual representation of workflows. Visual representation of workflows may be presented via a client device 120 or a lab-specific computing device. A user may enter information needed by for the workflow after a manual interference of the automation via client device 120, a lab-specific computing device, or via an interface included within the lab equipment itself. As referred to herein, “workflow” or “workflow path” refers to a sequential order of instructions, steps, procedures, protocols, tasks, or other procedures or processes that directs the lab system towards a specific outcome or result.

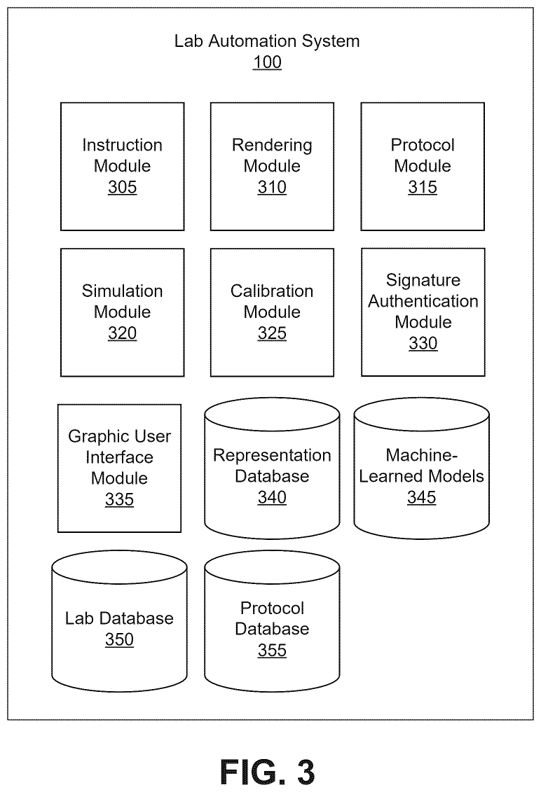

The network 110 connects the client devices 120 to the lab automation system 100, which is further described in relation to FIG. 3. The network 110 may be any suitable communications network for data transmission. In an embodiment such as that illustrated in FIG. 1, the network 110 uses standard communications technologies and/or protocols and can include the Internet. In another embodiment, the network 110 use custom and/or dedicated data communications technologies.

The labs 140 are connected to the lab automation system 100 via the network 110. A lab 140 is a physical space equipped for completing research, experiments, or manufacturing of various products. Each lab 140 includes one or more of robots 150, a camera system 160, lab equipment 170, and reagents 180. The robots 150 may be mobilized to synthesize products or conduct research and experiments in the lab 140. Examples of robots 150 that may be used in the labs 140 are liquid handlers, microplate movers, centrifuges, cappers/decappers, sorters, labelers, loaders, and the like. Each robot 150 may include one or more sensors attached to elements of the robots 150, such as position sensors, inertial measurement units (IM Us), accelerometers, cameras, and the like. Each robot 150 may also include one or more tags attached to external elements of the robot 150. The tags may be visible in image data captured of the lab by the camera system 160, described below, such that the lab automation system may determine positions of the external elements of the robots 150 and calibrate cameras of the camera system 160 based on the tags.

Each lab 140 may include a camera system 160 comprising one or more cameras. The cameras may be video cameras, infra-red cameras, thermographic cameras, heat signature cameras, or any other suitable camera. The cameras of a camera system 160 may be interspersed throughout a lab 140 to capture images and/or video of the lab 140, which may be used by the lab automation system 100 to calibrate the robots 150 and/or lab equipment 170 within the lab.

The lab equipment 170 (or, simply, “equipment”) in the lab is used by the robots 150 and/or human operators to manufacture products from materials (e.g., reagents 180) or conduct experiments/research within the lab. Each piece of equipment 170 may be operated by robots 150, human operators, or both. Examples of equipment 170 may include pipettes, beakers, flasks, plates, storage equipment, incubators, plate readers, washers, centrifuges, liquid handlers, sealers, desealers, or any other suitable equipment used in labs 140. The equipment may be used to synthesize products based on one or more reagents 180 stored in the labs 140. Reagents 180 are substances that may be mixed together for chemical reactions. Examples of reagents 180 stored in the labs 140 may include acetic acid, acetone, ammonia, ethanol, formaldehyde, hydrogen peroxide, sodium hydroxide, and the like. The lab automation system 140, which is further described in relation to FIG. 3, maintains a record of the robots 150, equipment 170, and reagents 180 stored at each lab 140 connected to the lab automation system 100.

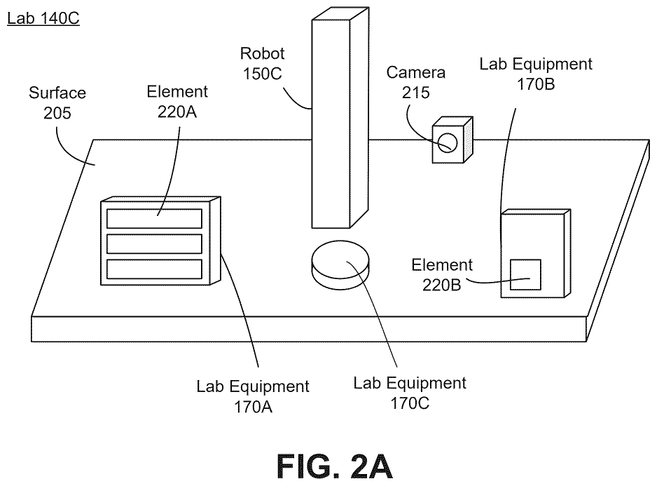

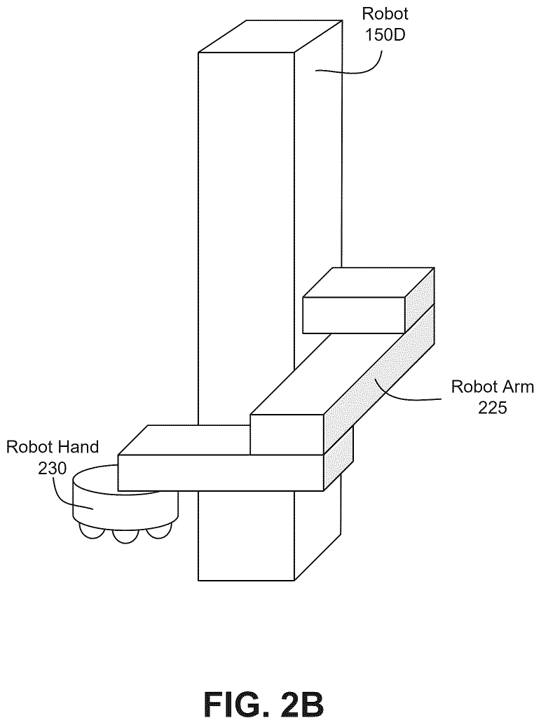

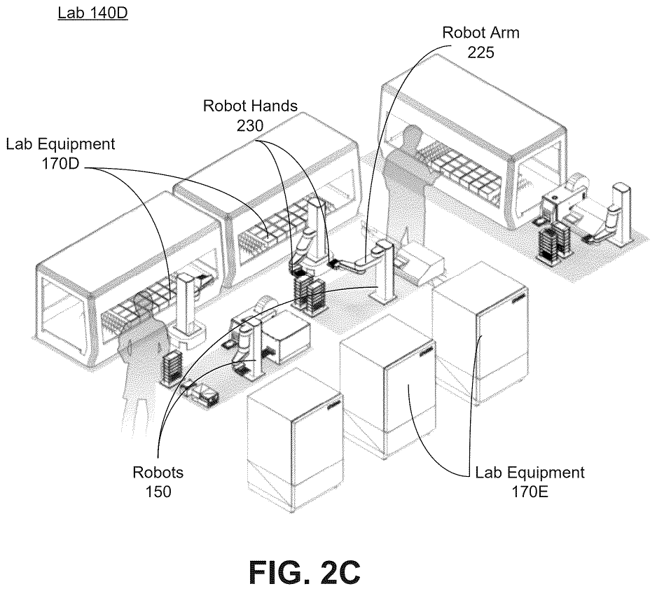

FIG. 2A illustrates components of a lab 140C, according to one or more embodiments. The lab 140C includes a surface 205 and may include one or more components such as robots 150, equipment 170, and reagents 180. In particular, the lab 140C includes a robot 150C programmable to perform operations in the lab 140C (e.g., by interacting with pieces of equipment 170). In the example of FIG. 2A, the lab 140C additionally includes a camera 215 positioned to receive image data describing the lab 140C. In other examples, the camera 215 may be mounted in different locations in the environment 200 or may be incorporated in the robot 150C or attached to an element 220 of a component.

FIG. 2B illustrates an example robot 150D configured to perform procedures in a lab 140D according to one or more embodiments. In the embodiment of FIG. 2B, the robot 150D includes components including a robot arm 225 and a robot hand 230. A camera of a camera system 160 in the lab 140D enables the lab automation system 100 to receive image data describing the lab 140D, including the robot 150D and any pieces of equipment 170 in the lab 140D. The robot arm 225 includes one or more jointed, moveable pieces with one or more degrees of freedom of motion, and connects a body of the robot 150D to the robot hand 230. The robot hand 230 includes one or more jointed, moveable pieces configured to interact with the components in the lab 140D. For example, the robot hand 230 can include a set of digits, pincers, or claws for moving and lifting pieces of equipment 170 such as pipettes, beakers, and the like, and for interacting with pieces of equipment 170, e.g., inputting or modifying settings, accessing compartments, and the like. In other embodiments, the robot 150D may include additional, fewer, or different elements than those shown in FIG. 2B, and the robot arm 225 and/or the robot hand 230 may include different elements than those shown in FIG. 2B.

FIG. 2C illustrates a lab 140D, according to one or more embodiments. The lab 140D includes lab equipment 170 and robots 150 with robot arms 225 and robot hands 230. The robots 150 may interact with the lab equipment 170 to move reagents and other materials for lab protocols conducted in the lab 140D. For instance, the robots 150 may access a reagent stored in lab equipment 170E and transfer the reagent to lab equipment 170D using pipettes held by the robot hands 230. Though numerous components are shown in FIG. 2C (e.g., lab equipment such as refrigerators, cabinets, venting systems, etc. and robots such as liquid handlers), other labs 140 connected to the lab automation system 100 may contain other components in other configurations throughout the labs 140. The automation system 100 for a lab 140 may create and execute within the lab 140 an automated workflow, which can include steps performed by both robots and humans.

### Lab Automation System

FIG. 3 illustrates a high-level block diagram of the lab automation system 100, according to one or more embodiments. The lab automation system 100 includes an instruction module 305, a rendering module 310, a protocol module 315, a simulation module 320, a calibration module 325, a signature authentication module 330, a graphic user interface module 335, a representation database 340, one or more machine learned models 345, a lab database 350, and a protocol database 355. In some embodiments, the lab automation system 100 may include additional or alternative modules or databases not shown in FIG. 3. In other embodiments, the functionality described as performable by the various components may be differentially distributed across the components.

The instruction module 305 determines steps from a set of instructions. The instruction module 305 receives instructions from the graphic user interface module 335. The instructions indicate how to perform a protocol in a lab 140. The instructions are input received from a user via a graphic user interface displayed via a client device 120, received from a pre-stored workflow, or generated based on a desired functionality specified by a user or a workflow. The instructions may be in the form of text or via a visual drawn path. For example, the text of instructions may indicate to “load holders into Hamilton liquid handler, load aluminum polymer, and pipette polymer into holders.” In another example, the instructions may be a drawing of lines connecting a set of wells from a storage to a Hamilton liquid handler. Furthermore, instructions may be translations of other instructions, or may be based on previously performed instructions. For example, when the instructions indicate that a step be performed by equipment not available within a lab, a translation or adaptation of previous instructions may include instructions to use an alternative piece of equipment with similar properties and uses. The full set of instructions represents a workflow. Some steps within the workflow can be robot performed and some can be human performed. Workflows can be stored for later use. In one or more embodiments, the instruction module 305 may receive target objectives for an experimental workflow. The target objectives may specify one or more objectives to be achieved by the experimental workflow. For example, one objective may be to identify a set of antibodies with at least a threshold binding affinity to a target antigen.

The instruction module 305 converts the text of the instructions into a set of steps. For instance, the instruction module 305 may identify verb phrases within the instructions that indicate operations that need to be done for the protocol. The verb phrases may each include a verb and one or more dependent words that the verb describes, and each verb phrase may correspond to a step. For example, the instruction may identify three verb phrases in the text “load holders into Hamilton liquid handler, load aluminum polymer, and pipette polymer into holders”: “load holders,” “load aluminum polymer,” and “pipette.” In some embodiments, the instruction module 305 may apply one or more natural language processing methods and/or machine-learned models 345 to determine the steps of the instructions. The machine learned model 345 may be trained on example texts labeled with one or more steps. The instruction module 305 may store the determined steps in association with the text or a colloquial name of the protocol, which may be received with the text from the graphic user interface module 335, in the protocol database 355.

The instruction module 305 identifies one or more of an operation, lab equipment 170, and reagent 180 for each step of the set of steps. An operation may be described by a verb of the verb phrase associated with the step. The operation may be performed using one or more of lab equipment 170, robots 150, and/or reagents 180 (e.g., components), which may be a complement phrase or adjunct phrase explicit in the verb phrase. For instance, the lab equipment 170 and reagent 180 may be represented by one or more nouns following the verb (e.g., “the holders” and “the aluminum polymer” in the step “load the holders with the aluminum polymer.”). In some embodiments, the lab equipment 170 and reagents 180 may be implicit in the step. For instance, the step “load the saline solution” may be associated with the robot “Hamilton liquid handler,” which is used to load reagents in labs 140. In some embodiments, the instruction module 305 may identify the operation, lab equipment 170, robot 150, and/or reagent 180 for each step using one or more natural language processing methods (e.g., creating a syntax tree) and/or machine learned model(s) 345 trained on a set of example steps labeled with operations, lab equipment 170, and reagents 180. The instruction module 305 stores the identified operations, lab equipment 170, and reagents 180 with the associated steps in the protocol database 355.

In some embodiments, the instruction module 305 may determine a lab 140 to perform the protocol in based on the text of the instructions. In some instances, the text may be associated with a particular lab 140 indicated by a user of where to perform the protocol associated with the instructions. In other instances, the instruction module 305 may determine a lab 140 for the protocol to be performed in by parsing the text to identify a noun (and one or more descriptive adjectives) representing a lab 140 and compare the parsed text to an index in the lab database 350 that associates labs 140 with colloquial names used by operators, locations of the labs 140, equipment 170, and reagents 180 stored at the labs 140, and the like. For example, the instruction module 305 may determine the text “prep holders in main street lab” is associated with “Lab 1 on Main Street” of the lab database 350. Further, the instruction module 305 may select a lab 140 based on parameters received with the instructions and additional factors such as schedules of the labs 140, operator availability at each lab, equipment available at each lab, reagents available at the lab, and the like. The parameters may describe a desired protocol location for performing the protocol, a desired proximity to the protocol location, equipment preferences, reagent preferences, budget for the protocol, desired amount of automation for the protocol, desired quality level, and the like.

The instruction module 305 may detect one or more ambiguities in the identified operations, equipment 170, and reagents 180 of the steps. An ambiguity may be a word or phrase of the instructions that the instruction module 305 is unable to map to a component (not including prepositions, articles, and conjunctions). To detect ambiguities, the instruction module 305 may remove articles, conjunctions, and prepositions from the instructions and cross-reference each word with the lab database 350 and/or an external dictionary. If the instruction module 305 is still unable to resolve the ambiguity, the instruction module 305 may send an indication to the graphic user interface module 335 to present one or more words associated with the ambiguity to a user and receives one or more selected words from the graphic user interface module 335. The instruction module 305 updates the steps in the protocol database 355 based on the selected words.

The instruction module 305 may also detect one or more errors in the steps. An error may be a combination of one or more components that could not practically function together to perform an operation or using components to perform an operation that would violate a set of safety protocols. The instruction module 305 may detect errors using a combination of natural language processing and information about labs 140 in the lab database 350. For instance, the instruction module 305 may detect the textual segment “move refrigerator with liquid handler” as including an error since the liquid handler is used to move liquids and could not lift the refrigerator. To resolve an error, the instruction module 305 may send a list of components associated with a step to the graphic user interface module 335 for display to a user. The instruction module 305 receives a selection of one or more components from the graphic user interface module 335 and updates the step in the protocol database 355 to use the selected components. In some embodiments, the instruction module 305 may determine one or more variants for the components or operation and update the protocol with the variants.

The instruction module 305 may determine a set of variants for the components of each step. Variants are alternate components that may be used in place of the lab equipment 170, robots 150, and reagents 180 (henceforth “determined components” for simplicity). Each variant may have the same or alternate (e.g., similar) functionality to a corresponding determined component. For instance, variants with the same functionality may perform or be used for the exact same operations as a corresponding determined component. For example, a first robot may be able to lift up 20 pounds of material for an operation, and a second robot that can lift up to 30 pounds of material would be a variant of the first robot. Variants with alternate functionality may perform or be used for substantially similar operations to the determined components. For example, a first reagent may have a specific reaction when mixed with a second reagent. A variant of the first reagent may be a third reagent 180 that has the same specific reaction with the second reagent 180 (in instances where no other reagents are mixed with the described reagents 180). In some embodiments, the instruction module 305 may also determine variants with limited overlapping functionality to the components. In further embodiments, the instruction module 305 may determine the variants based on parameters received with the instructions. The instruction module 305 may account for the parameters (e.g., cost and time to perform the protocol, skillset required of a human operator, etc.) in determining variants.

The instruction module 305 may determine the variants by accessing an index of the lab database 350 to cross-reference components used to perform the same operations. For instance, the instruction module 305 may determine that the lab equipment “liquid holder,” “pipette machine,” and “handheld dispenser” may all be used to dispense liquid and relate the lab equipment 170 as variants of one another in the lab database 350. In some embodiments, the instruction module 305 may apply a machine learned model 345 to the components to determine the variants. The machine learned model may be trained on components labeled with sets of variants. The instruction module 305 may store the variants with the associated components in the protocol database 355. In some embodiments, the instruction module 305 may determine a set of projections for performing the protocol using each of the one or more variants. Each projection is a list of steps for the protocol using the variant and may include manual (e.g., performed by a human operator) and/or automatic (e.g., performed by a robot 150) steps. The instruction module 305 stores the projections for each variant in the protocol database 355.

The instruction module 305 may also determine variants of the operations of the steps. Variants of the operations are alternate methods of performing the operations. For instance, the operation “separating the reagent into 10 holders” may be mapped to the automatic operation of “dividing” a reagent into equivalent amounts between 10 holders. The instruction module 305 may determine that a human operator manually adding the reagent to each of the ten holders would be a variant of the operation that is a different way of resulting in the same outcome (e.g., the reagent separated into the holders). The instruction module 305 may cross-reference in the lab database to determine variants or may apply a machine learned model 345 to each operation to determine a variant. The machine learned model 345 may be trained on operations labeled by a human operator with a set of variants. The instruction module 305 may store the variants with the associated operations in the protocol database 355. In some embodiments, the instruction module 305 may store the variants with indication of whether a variant is done automatically (e.g., by a robot 150) or manually (e.g., by a human operator).

The instruction module 305 may also determine variants of the labs 140 for performance of the protocol. Alternate labs 140 (e.g., the variants) include enough of the same or similar components and may have enough of the same or similar operations performed in the alternate lab 140 to the selected lab 140 that the protocol can be performed in the alternate lab 140. The instruction module 305 may access the variants of the components and operations from the protocol database 355 and input the components and operations, along with their variants, to a machine learned model 345 configured to select alternate labs based on components and variants. The machine learned model 345 may be trained on labs 140 labeled with components that are in and operations that may be performed in the lab 140. In other embodiments, the instruction module 305 cross-references the components, operations, and the variants in the lab database 350 to select a lab 140 that includes components and may have operations performed in the lab 140 to complete the protocol. The instruction module 305 stores the variants of the labs in association with the labs in the lab database 350 and/or the protocol database 355.

The instruction module 305 sends the set of steps, each with an identified operation, lab equipment 170, robot 150, and/or reagent 180, to the protocol module 315 along with the lab 140 to perform the protocol in. In some embodiments, the instruction module 305 may send one or more variants to the graphic user interface module 335 for selection by a user, and upon receiving a selection, send the selection to the protocol module 315 for performance in the lab 140. In further embodiments, the instruction module 305 may receive requests for variants for a protocol from the protocol module 315 and communicate with the protocol module 315 to determine the variants for the protocol. The instruction module 305 also sends the set of steps and associated operations, lab equipment 170, robots 150, reagents 180, and lab 140 to the simulation module 320 for simulation in a virtual representation of the lab 140. In some embodiments, the instruction module 305 may send one or more variants to the graphic user interface module 335 for selection by a user, and upon receiving a selection, send the selection to the simulation module 320 for simulation in the virtual representation.

In some embodiments, the instruction module 305 may group one or more protocols for performance in a lab. For instance, the instruction module 305 may receive multiple sets of instructions indicating protocols to perform in a lab 140. The instruction module 305 may determine, based on the components required for each protocol, which protocols can be performed simultaneously or sequentially in a single lab 140 and create a grouped protocol including steps of the determined protocols. The instruction module 305 may send the grouped protocol to the protocol module 315 for performance in the lab 140.

The rendering module 310 renders virtual representations of labs 140. A virtual representation (or graphical representation) of a lab 140 includes one or more virtual elements representing components in the lab 140 in positions corresponding to the actual positions of the components in the actual lab 140. The virtual elements may be labeled based on the corresponding components. In some embodiments, the virtual elements may include a virtual operator representing a human operator who may perform manual operations in a lab 140. Examples of virtual representations are shown in FIGS. 2A and 2C. The virtual representation may also include a visual representation of a workflow path through the lab 140 and the associated virtual elements. The visual representation of the workflow path is tied to the specific virtual elements associated with each step of the workflow path, and the rendering module 310 may render the workflow path to include each step as well as a progress bar to allow a user to follow along the virtual representation of the workflow path, step by step.

The rendering module 310 receives image data from a camera system 160 of a lab 140. The image data may depict a lab 140 and include camera and video data of the lab 140. In some embodiments, the rendering module 310 may also receive, from the graphic user interface module 335, a list of components and corresponding coordinates in the lab 140. The rendering module 310 may also receive sensor data from one or more components in the lab 140.

The rendering module 310 creates virtual elements representing each component based on the image data of the component (e.g., if a liquid handling robot is shown in the image data, the rendering module 310 creates a virtual element depicting the liquid handling machine). In some embodiments, the rendering module 310 saves the virtual elements in the representation database 340 and uses the virtual elements for similar components when rendering other new labs 140. The rendering module 310 renders a virtual representation of the lab 140. In some embodiments, the rendering module 310 dynamically localizes a scene of the lab 140 from the image data using a three-dimensional model that performs spatial abstraction to create the virtual representation. In other embodiments, the rendering module 310 renders the virtual representation by mapping the virtual elements shown in the image data to a virtual area representing the new lab 140. For instance, the rendering module 310 may determine a location of a robot 150 based on the image data (and/or sensor data indicating a position of the robot) and maps a virtual element representing the robot 150 to a corresponding location in the virtual area. The rendering module 310 stores the virtual rendering in the rendering module 310 in association with the lab 140.

The rendering module 310 may also store information received from the graphic user interface module 335 about the components in the lab 140 in the lab database 350 in relation to the lab 140. For instance, the rendering module 310 may receive text for labeling the virtual element from the graphic user interface module 335. The rendering module 310 may determine a user associated with the test and stores the text in association with the virtual element and the user in the representation database 340. The rendering module 310 may additionally store the text in association with the component the virtual element represents in the lab database 350 and/or protocol database 355, such that the user may reference the component using the text when requesting protocols be performed in a lab 140. The rendering module 310 may also embed image data into the virtual representation. For instance, the rendering module 310 may embed image data of components form various angels in the lab 140. In another instance the rendering module 310 may embed image data depicting instructions for performing steps of a protocol or a specific operation in the lab 140.

The protocol module 315 configures robots 150 in a lab 140 to perform protocols based on the cues from the scheduler 395. Protocols are sub-portions of a workflow path directed towards specific robots or machines. The protocol module 315 receives a set of steps and associated robots 150, operations, lab equipment 170, and reagents 180 from the instruction module 305. For each step, the protocol module 315 configures the associated with the step to perform the operation associated with the step. The protocol module 315 may additionally configure the robot 150 to interact with the lab equipment 170 (if any) and access and use the reagent 180 (if any) associated with the step to perform the operation. The protocol module 315 can implement and execute the steps of different workflow paths in a lab 140 simultaneously. In some embodiments, the protocol module 315 may request variants for the protocol from the instruction module 305 and modify the protocol with one or more variants. The protocol module 315 may, in some instances, request for the simulation module 320 to simulate the protocol with one or more variants to determine an experimentation time for the protocol. The experimentation time is the estimated amount of time needed to complete the protocol in the lab 140. The protocol module 315 may select the variants associated with the lowest experimentation time and modify the protocol in the protocol database 355 to use those variants. As the protocol module 315 executes the protocols and updates the protocols to be implemented, the protocol module 315 may provide the scheduler 395 with updates on the completion of protocols and next steps.

The simulation module 320 simulates protocols occurring within labs 140. The simulation module 320 receives request to simulate a protocol in a lab 140. The request may be from the graphic user interface module 335. The simulation module 320 may request a set of steps for the protocol from the instruction module 305 or access a set of steps for the protocol from the protocol module 390. In another embodiment, the request may be in the form of receiving a set of steps to be performed in a lab 140 and associated operations, lab equipment 170, robots 150, and reagents 180 from the instruction module 305.

The simulation module 320 accesses a virtual representation of the lab 140 in the representation database 340. For each step received from the instruction module 305 for the protocol, the simulation module 320 determines which virtual elements of the virtual representation correspond to the components associated with the step. The simulation module 320 determines, based on the operation associated with the step, how the one or more components would need to move within the lab 140 for the operation to be performed and moves the corresponding virtual elements accordingly in the virtual representation of the lab 140. The simulation module 320 may additionally highlight the virtual elements in the virtual representation. The simulation module 320 accesses the lab database 350 to determine whether the movement of components associated with the virtual elements would cause any issues during performance of a protocol. Issues may include robots 150 or lab equipment 170 overlapping, a robot 150 being unable to perform an operation, lack of availability of lab equipment 170 and reagents 180 in the lab 140, and the like, and the lab database stores information describing which components have the ability to stack, overlap, and interact with other components. The simulation module 320 sends the virtual representation with the moved virtual elements and any detected issues to the graphic user interface module 335 for each step.

The simulation module 320 also simulates protocols occurring within a lab 140 in real-time. The simulation module 320 receives requests from the graphic user interface module 335 for simulations of protocols being currently performed in labs 140. For a request, the simulation module 320 accesses a virtual representation of a lab 140 in the representation database 340. The simulation module 320 receives sensor data from robots 150, equipment 170, and a camera system 160 in a lab 140. The sensor data may include image data of the lab 140, position data of components of the robots 150 and/or equipment 170, and any other suitable sensor data. Based on the sensor data, the simulation module 320 determines how the components within the lab 140 have been moved as a protocol is performed and moves corresponding virtual elements in the virtual representation of the lab 140 to mirror the movement of the components. The simulation module 320 may additionally highlight virtual elements corresponding to components being used or moved in the lab 140. The simulation module 320 sends an indication to the graphic user interface module 335 that the virtual representation of the lab 140 is being updated to show the protocol being performed in real-time. Once the protocol is completed, the simulation module 320 stores the virtual representation of the lab 140 showing the current state of the lab 140 (e.g., the current positions of the components in the real-world lab 140) in the representation database 340.

The simulation module 320 may also simulate variants of a protocol. The simulation module 320 may receive requests from the graphic user interface module 335 to simulate one or more variants for a protocol. In some embodiments, the request may be associated with a set of parameters. The parameters may describe a desired protocol location for performing the protocol, a desired proximity to the protocol location, equipment preferences, reagent preferences, and the like. The simulation module 320 may select one or more variants to simulate for the protocol to optimize satisfying the parameters (e.g., selecting operations that take less time, cost within the budget, etc.). The simulation module 320 modifies a copy of the virtual representation of the lab 140 to depict the simulation of each variant. In some embodiments, the simulation module 320 may modify the copies in different colors depending on the type of variant. For example, the simulation module 320 may modify the copies to show variants that occur automatically in a first color and variants that occur manually in a second color. The simulation module 320 may store the modified copies in the representation database 340 in association with the variants.

In some embodiments, the simulation module 320 may receive a list of projections for a variant and simulate the projections in the lab 140. A projection is a list of steps and associated operations and components necessary to perform the entire protocol. The simulation module 320 may determine, for each projection, potential errors that may occur if the protocol were performed according to the projection, such as running out of lab equipment 170 or reagents 180, robots 150 blocking one another in the lab 140, scheduling conflicts, and the like. The simulation module 320 modifies a copy of the virtual representation based on simulation of the projections and sends the modified virtual representation to the graphic user interface module 335 for display after completion of the simulation of each step.

In one or more embodiments, the simulation module 320 may perform one or more simulations to evaluate efficiency in the workflow of the autonomous lab based on capturing one or more signatures from operators of the autonomous lab. For example, the simulation module 320 may project completion times for one or more of the protocols. Based on the projected completion times, the simulation module 320 may predict a likelihood that at least one user authorized for signoff of the protocol is present at the autonomous lab. The simulation module 320 may predict the likelihood by leveraging a machine-learning model trained on historical foot traffic of operators in the autonomous lab. If the likelihood is below a certain threshold, the simulation module 320 may provide such indication to the protocol module 315. The protocol module 315 may leverage such insight into reordering protocols and/or modifying the scheduled start times for the protocols.

The calibration module 325 calibrates cameras of the camera systems 160 connected to the lab automation system 100. The calibration module 325 receives requests to calibrate one or more cameras from the graphic user interface module 335. In some embodiments, the calibration module 325 may periodically calibrate the cameras connected to the lab automation system 100 without receiving an explicit request from the graphic user interface module 335. The calibration module 325 requests image data from the one or more cameras and associates subsets of the image data with its respective camera that captured the image data. The calibration module 325 stores the image data in the lab database 350 in association with the lab 140 and the camera.

For each camera of the one or more cameras, the calibration module 325 determines which lab 140 the camera is located in and requests sensor data from sensors connected to one or more components in the lab 140. The calibration module 325 stores the sensor data in the lab database 350 along with identifiers of the components and the lab 140. The calibration module 325 determines a position of one or more elements 220 of each component based on the sensor data. For instance, the sensor data may indicate position coordinates of a robot arm 225 and robot hand 230 of a robot 150 in the lab 140. In another instance, the position data may indicate the position of an element 220 of a robot 150 relative to a stationary base of the robot 150, the coordinates for which the calibration module 325 may access in the lab database 350.

The calibration module 325 locates tags physically attached to the components in the image data. Each tag may include information encoded on the tag indicating which element 220 of a component the tag is on and may vary in shape, size and color. The calibration module 325 may store information describing where the tags are located and shape, size, and color of the tags in the lab database 350. The calibration module 325 may apply a machine-learned model 345 to the image data to locate tags within the image data. The machine-learned model 345 may be trained on image data with pixels labeled as including a tag or not and coordinates of the tag and may be a classifier, regression model, decision tree, or any suitable model. The calibration module 325 may further determine depth information about the image data based on the tags shown in the images and each tag's associated shape, size, and color.

The calibration module 325 determines the location of the camera based on the determined positions of the components and locations of tags, such as by triangulating. In some embodiments, the calibration module 325 may also account for distortion of the lens of the camera. The distortion may have been previously entered for the camera by an external operator or the calibration module 325 may determine the distortion based on the locations of the tags and/or positions of the components. The calibration module 325 calibrates each camera based on the camera's determined location such that the calibration module 325 may determine locations of other components shown in image data captured by the camera given the camera's determined location.

The calibration module 325 may determine the location of components in a lab 140 using image data from calibrated cameras. The calibration module 325 may receive a request for the location of a particular component in a lab 140 or may periodically determine locations of components in each lab 140. The calibration module 325 accesses image data captured by one or more calibrated cameras in the lab 140 and locates one or more tags that are visible on the particular component. The calibration module 325 determines the location of the particular component based on the location of the one or more tags.

In some embodiments, the calibration module 325 may determine that a camera needs recalibration based on new image data captured by the camera. The calibration module 325 receives new image data from the camera in real-time and determines one or more components shown in the new image data. The calibration module 325 may also request new sensor data from the one or more components (if available, such as when one or more of the components is a robot 150 with an internal camera) in the new image data. The calibration module 325 retrieves historical image data and corresponding historical sensor data from the lab database 350 captured by the camera and determines which components have not moved in the lab 140 based on the historical sensor data and the new sensor data. The calibration module 325 compares the location of the components that have not moved between the historical image data and the new image data. In some embodiments, the calibration module 325 may do so using a machine-learned model 345 trained on sets of image data labeled with discrepancies (e.g., a component appearing in unexpected pixels in the image data). If the calibration module 325 determines that a component does not appear where expected, the calibration module 325 recalibrates the camera. Alternatively, the calibration module 325 may determine which pixels of the image data should show the component in an expected location based on the new sensor data and analyze the new image data to determine if the component is in the expected location. The calibration module 325 recalibrates the camera if the component is not shown in the determined pixels.

The signature authentication module 330 captures authenticated signatures from operators for signoff of various protocols in the automated workflow. The signature authentication module 330 maintains one or more signature lists of users. The signature authentication module 330 may associate login information and/or authentication information for each user in the one or more signature lists. When crafting the workflow for the autonomous lab, the signature authentication module 330 may indicate, for each protocol, whether the protocol needs signoff from an individual in one or more of the signature lists. In a first example, one protocol may need signoff from at least one individual from one signature list. In a second example, one protocol may need signoff from at least one individual from a first signature list and signoff from at least one other individual from a second signature list. In a third example, one protocol may need signoff from at least one individual from either a first signature list or a second signature list. In a fourth example, one protocol may need signoff from at least two, at least three, or at least four individuals from one or more of the signature lists. Various combinations of the above examples may be implemented.

The signature authentication module 330 may capture signature(s) through a graphical user interface. The graphical user interface may present a status report on the protocol performed by the autonomous lab. For example, the status report may indicate a total time to completion, any issues along the way, etc. The status report may further include images captured by the camera system of the autonomous lab. The status report may include any other contextual information regarding the completed protocol. Provision of such contextual information regarding the completed protocol provide additional insight to an authorized user providing signoff on the protocol. The graphical user interface may include an option for inputting the user's signature. In some embodiments, the option may be a drawing box, in which the user may hand scribe their signature. In other embodiments, the option may be a virtual button for adopting an electronic representation of the user's signature. The graphical user interface may further indicate signoff(s) provided by other users. For example, in the case multiple signoffs may be needed for one protocol, the graphical user interface may present any prior signoffs so that a later signing individual may have insight into others that have previously signed.

In some embodiments, the signature authentication module 330 may push out notifications to one or more client devices (e.g., client devices 120) associated with users in the one or more signature lists. The signature authentication module 330 may push out the notifications indicating that one or more protocols need signoff from the user. In some embodiments, the signature authentication module 330 may push out a notification indicating signoff need in the future, i.e., based on time of completion of the protocol needing signoff. In some embodiments, the signature authentication module 330 may temporally align a push notification with steps designated for a human operator (assuming the human operator is an authorized user for signoff). Such synchronization can limit human touches in the automated workflow, and can minimize any delays caused by human signoff. In some embodiments, the signature authentication module 330 may batch multiple protocols needing signoff into one set of notifications. Accordingly, the signature authentication module 330 may compact the number of instances that a user would need to check into the autonomous lab. For example, instead of requesting signoff as protocols are completed in real-time (resulting in multiple signoff instances), the signature authentication module 330 may batch multiple signoffs into one instance. In some embodiments, the notification may include an option for responding to the request for the signature. Upon receipt of a user's input indicating that the user will signoff on the protocol, the signature authentication module 330 may push out another notification updating other users, to prevent redundant signoffs between authorized users. The signature authentication module 330 may also push out a notification updating other users when a signoff is completed, i.e., a signature is captured by another authorized user.

The signature authentication module 330 may capture signature(s) from the users and generate a lab log including the signatures appended to the protocol associated with the signature. The lab log may be stored in the protocol database 355, or some other database of the lab automation system 100. The lab log may indicate the user that provided each signature, and may further indicate authentication information when capturing the signature from the individual. For example, the authentication information may indicate date of signature, time of day of signature, client device used to provide the signature, manner of authentication, other details regarding authentication, etc.

In one or more embodiments, the signature authentication module 330 may provide captured signature(s) to the protocol module 310. In such embodiments, progression through the workflow of protocols may be contingent on signoff by user(s). As such, if signoff is not yet completed, the protocol module 310 may be prevented from progressing to a subsequent protocol. In some embodiments, the signature authentication module 330 may receive an indication form the authorized user that an issue in the protocol prevents signoff. In such embodiments, the signature authentication module 330 may provide the indication that the issue is preventing signoff to the protocol module 310, which may restart a protocol, modify the existing protocol, modify the workflow, cancel the workflow, or otherwise request further instructions on how to proceed.

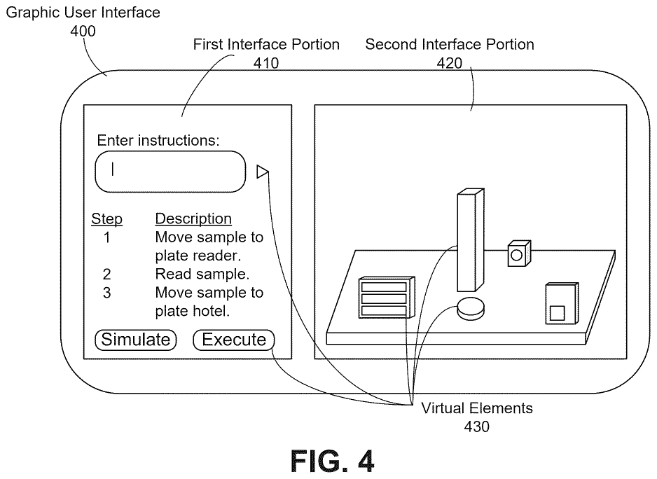

The graphic user interface module 335 generates graphic user interfaces for display on one or more client devices 120 connected to the lab automation system 100. Examples of graphic user interfaces are described with respect to in FIGS. 4-6. The graphic user interface module 335 receives, from a client device 120, a request to view a virtual representation of a lab 140. The graphic user interface module 335 retrieves the virtual representation from the representation database 340 or requests a virtual representation from the rendering module 310. The graphic user interface module 335 renders the virtual representation in the graphic user interface. The virtual elements of the virtual representation may be interactive elements that a user may interact with. For instance, upon receiving a mouseover of a virtual element via the graphic user interface, the graphic user interface module 335 may cause the virtual element to become highlighted within the virtual representation or mimic an operation being performed. Further, upon selection of a virtual element, the graphic user interface module 335 may present a tag element connected to the virtual element. A user may enter text to the tag element to label the virtual element and its associated component with. The graphic user interface module 335 sends the text to the rending module 320 for addition to the virtual representation in the representation database 340.

The graphic user interface module 335 may receive as input instructions via a drawn path between virtual elements. The graphic user interface module 335 may also render the instructions that form the workflow path visually as a drawn path through the lab, connecting the virtual representations of each piece of lab equipment. Upon a selection of a virtual element, the graphic user interface 355 may present options to the user regarding how the user can connect the virtual elements. For example, options may include whether the path splits at a given virtual element, or loops back.

The graphic user interface module 335 renders one or more interactive elements in the graphic user interface. The interactive elements may allow a user to move virtual elements associated with components in a lab, enter coordinates of components in a lab, request a simulation of a protocol, request calibration of one or more cameras, request variants for a protocol, and the like. The interactive elements may also allow a user to select a mode for the graphic user interface to operate in. For example, a first mode may cause the graphic user interface to display simulations of protocols in a virtual presentation and a second mode may cause the graphic user interface to mimic, in real-time, protocol that is currently being performed in a lab.

The graphic user interface module 335 may display one or more simulations of protocols in a lab via the graphic user interface. The graphic user interface module 335 receives, via an interaction with an interactive element of the graphic user interface, a request to simulate a protocol in a lab 140. The graphic user interface module 335 requests a simulation of the protocol in the lab from the simulation module 320. The graphic user interface module 335 receives a virtual representation of the lab with virtual elements moved for each step of a protocol and presents the virtual representation via the graphic user interface. In some embodiments, the graphic user interface may include an interactive scrolling element that allows a user to increment through each step in the virtual representation. The graphic user interface module 335 may receive detected issues for each step from the simulation module 320 and presents the detected issues as alerts via the graphic user interface. The detected issues to the graphic user interface module 335 for each step.

In some embodiments, the request for the simulation may include one or more parameters. Examples of parameters include a desired experimentation time for the protocol, a budget, a necessary skillset for human operators, necessary equipment 170 and/or reagents 180, and the like. The graphic user interface module 335 sends the request with the parameters to the simulation module 320, which determines one or more variants to simulate to satisfy the parameters. Upon displaying the simulation in a virtual representation, the graphic user interface module 335 may display statistics representing whether the parameters are satisfied or not using the one or more variants.

The graphic user interface module 335 may also receive, via an interaction with an interactive element of the graphic user interface, a request to simulate a protocol that is currently occurring in a lab 140. The graphic user interface module 335 requests a simulation of the protocol the simulation module 320. The graphic user interface module 335 receives indications from the simulation module 320 as the simulation module 320 updates the virtual representation of the lab 140 in the representation database 340. The graphic user interface module 335 displays the updated virtual representation in real-time via the graphic user interface. In some embodiments, the graphic user interface module may also send notifications in response to receiving a request. For instance, if the graphic user interface module 335 receives a request for variants of a robot 150 in a lab 140 but the instruction module 305 indicates that none exist, the graphic user interface module 335 displays a notification on the graphic user interface indicating that no variants are available for the robot 150.

The graphic user interface module 335 may receive instructions via a text box of the graphic user interface. The instructions may be associated with a lab 140 and, in some embodiments, a set of parameters. The graphic user interface module 335 sends the instructions with the lab 140 and parameters to the instruction module 305. The graphic user interface module 335 may receive an indication of an ambiguity or error in the instructions from the instruction module 305. The graphic user interface module 335 may present one or more words associated with an ambiguity via the graphic user interface and receive a selection of one or more words via the graphic user interface, which the graphic user interface module 335 sends to the instruction module 305. The graphic user interface module 335 may also present one or more components associated with an error via the graphic user interface and receive a selection of one or more components via the graphic user interface, which the graphic user interface module 335 sends to the instruction module 305.

The graphic user interface module 335 may receive one or more variants from the instruction module 305 and displays the one or more variants in a selectable list via the user interface. For example, the variants may be a list of alternate labs 140 for the lab 140 for a user to select from. The graphic user interface may highlight, in the virtual representation, virtual elements of components associated with a variant upon receiving mouseover of the variant in the selectable list. In another embodiment, the graphic user interface module 335 may highlight virtual elements representing the variants in the virtual representation such that a user may interact with a highlighted virtual element to select a variant. The graphic user interface module 335 sends selected variants to the instruction module 305.

FIG. 4 illustrates a graphic user interface for the lab automation system 100, according to one or more embodiments. In other examples, the graphic user interface 400 may include additional, fewer, or different elements than those shown in FIG. 4. The graphic user interface 400 may be generated by the graphic user interface module 335 described previously. In the example of FIG. 4, the graphic user interface 400 includes a first interface portion 410 and a second interface portion 420. The first interface portion 410 enables a user of the lab automation system 100 to provide instructions in natural language to the lab automation system 100, which identifies operations, equipment, and/or reagents corresponding to the provided instructions, as described in reference to the instruction module 305. In some embodiments, the first interface portion 410 additionally enables a user to simulate or execute a protocol in response to steps being generated for provided instructions.

The second interface portion 420 includes a view of a lab 140. In some embodiments, the second interface portion 420 is a virtual representation of the lab 140 generated by the rendering module 310. Users of the graphic user interface 400 may modify the virtual representation by interacting with virtual elements 430 via the graphic user interface 400 and may request simulations of robots 150 performing the steps of a protocol for visualization or display within the virtual representation. In other embodiments, the second interface portion 420 is a live feed, representation, or view of the lab 140 captured via a camera system 160. In these embodiments, the second interface portion 420 displays the lab 140 in real-time or in near real-time as robots 150 perform protocols.

### Signature Authentication in Automated Lab Workflow

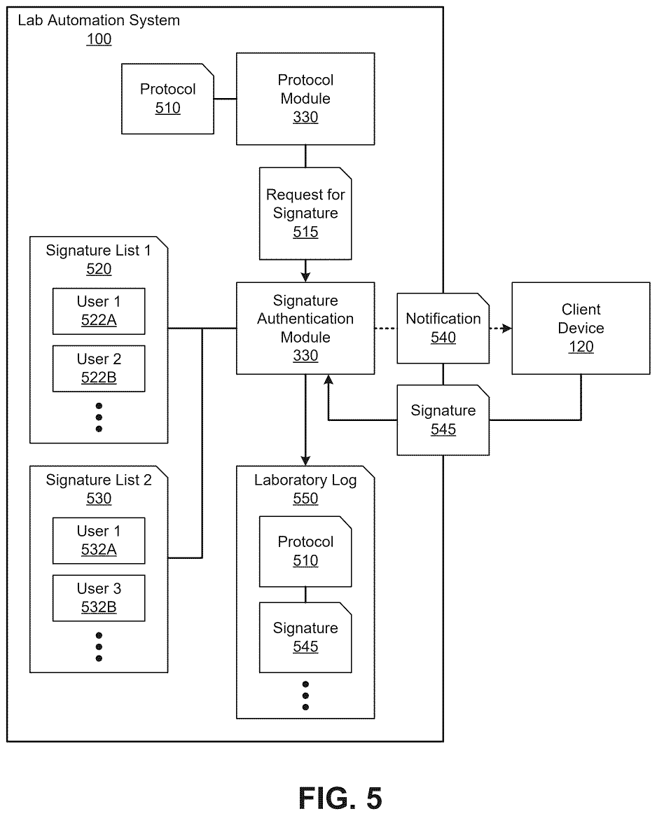

FIG. 5 illustrates a flowchart of a signature authentication workflow implemented in an automated lab environment, according to one or more embodiments. The signature authentication may be performed by the lab automation system 100, in conjunction with client devices (e.g., the client device 120) associated with operators of the autonomous lab.

The protocol module 330 manages protocols performed by the autonomous lab (e.g., the lab 140), including protocol 510. Protocol 510 may need signoff by one or more authorized users. The protocol module 330 provides a request 515 for signature to the signature authentication module 330. The request may specify which signature lists are authorized for signoff of the protocol 510. For example, one signature list may include one tier of technicians operating or overseeing the autonomous lab, whereas another signature list may include another tier of quality control specialists. Each protocol may have differing signoff needs. For example, the protocol 510 may need signoff from any user of Signature List 1 520 or Signature List 2 530. Or, in another example, the protocol 510 may need signoff from one user of Signature List 1 520 and one user of Signature List 2 530. In one or more embodiments, one user may be authorized in multiple signature lists, e.g., User 1 is authorized in Signature List 1 520 and Signature List 2 530. In some example implementations, the signoff may need different users, even though User 1 is authorized and listed in both signature lists, User 1 can only provide signoff for one of the signature lists, and the signature authentication module 330 would need to capture another signature from another user of the other signature list.

The signature authentication module 330 may push out a notification 540 to capture a signature 545 from the client device 120. In other embodiments, the client device 120 may provide the signature 545 without prompting by the notification 540. As the client device 120 connects to the lab automation system 100, the signature authentication module 330 may perform user authentication. The signature authentication module 330 may perform multi-factor authentication to verify the user's identify prior to capturing the signature 545. For example, the signature authentication module 330 may access the signature lists to identify whether the client device 120 is a device authorized for use by the user. If, for example, the client device 120 is not recognized, i.e., not authorized for use by the user, the signature authentication module 330 may reject the signature 545. If, on the other hand, the signature authentication module 330 validates the authenticity, the signature authentication module 330 may capture the signature 545. The signature authentication module 330 may generate the lab log 550 storing completion of the protocol 510 in addition to the authenticated signature 545.

### Example Methods

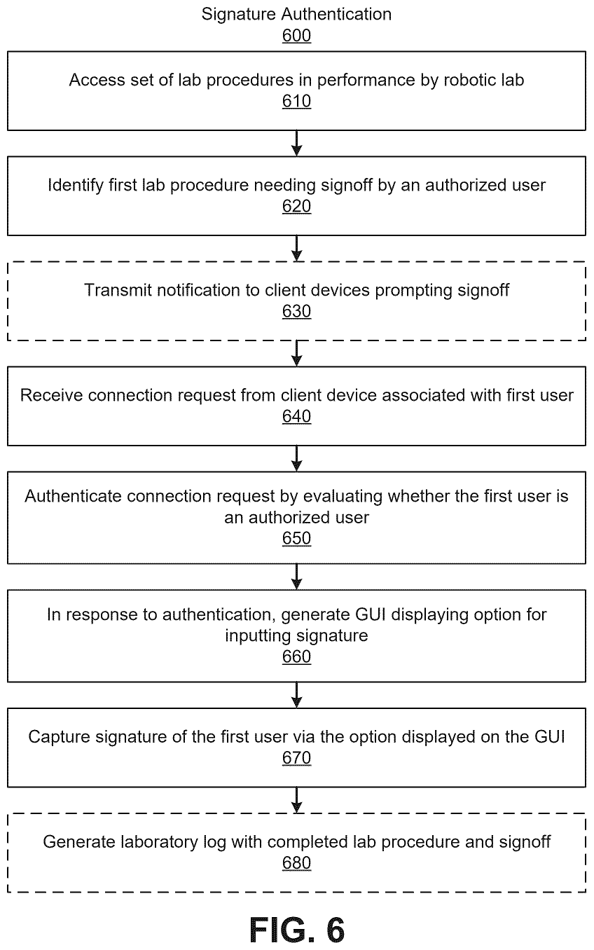

FIG. 6 is a process flowchart describing steps in signature authentication by a lab automation system, according to one or more embodiments. Although the process of signature authentication is described as being performed by the lab automation system, in other embodiments, other devices may perform some or all of the steps. In other embodiments, the signature authentication may include additional, fewer, or different steps than those listed herein.

The system accesses 610 a set of lab procedures in performance by the robotic lab. The robotic lab may include one or more robots in control of equipment in the laboratory environment. The lab procedures may include instructions for controlling operation of the one or more robots. Some procedures may need signoff from one or more authorized users.

The system identifies 620 a first lab procedure needing signoff by an authorized user. In one or more embodiments, the system may maintain differing lists of authorized users. For example, the lab procedure may need sign off from one user in either a first list or a second list. The lists may differ in which type of personnel are included in each respective list. In another example, the lab procedure may need sign off from one user in a first list and another user in a second list.

The system may transmit 630 a notification to computing devices prompting signoff of the first lab procedure. In some embodiments, the notification may indicate completion of the first lab procedure, or projected completion (e.g., in the near future). In some embodiments, the notification may be blast to computing devices associated with each of the users in the lists. In some embodiments, the system may batch signoffs for multiple completed lab procedures together.

The system receives 640 a connection request by a computing device including login information identifying a first user. The login information may include one or more identifiers, e.g., a username, a personnel key, a personnel-specific number, etc.

The system authenticates 650 the connection request by evaluating whether the first user is an authorized user. The system checks the appropriate lists to identify whether the first user is authorized.

The system, in response to the authentication, generates 660 a graphical user interface displaying an option for inputting a signature. The system may generate the graphical user interface on the computing device associated with the connection request. The graphical user interface may further display a status report of the completed lab procedure, e.g., including images captured by a camera system of the lab automation system. If the connection request is denied, the system can disable signoff functionality, thereby preventing the unauthorized user from signing off on the completed procedure.

The system captures 670 the signature of the first user via the option displayed on the graphical user interface. The signature may be an electronic hand-scribed signature, an electronic representation of a signature, etc. Upon capturing the signoff, the system may notify other users that signoff was captured, so as to prevent redundant signatures.

The system may generate 680 a laboratory log with the completed lab procedure and the captured signoff. The system may build out the log with additional completed procedures and signoffs. The system may store the log for subsequent viewing, e.g., another user may check the log for compliance with the workflow.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one or more embodiments, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
accessing a set of one or more lab procedures in performance by a robotic lab including one or more robots controlling lab equipment, wherein each lab procedure includes one or more instructions for controlling operation of the one or more robots;
identifying a first lab procedure of the set of lab procedures for signoff by one authorized user of a list of users;
transmitting a notification to one or more computing devices indicating completion of the first lab procedure and prompting signoff of the first lab procedure;
receiving a connection request by a computing device, the connection request including login information identifying a first user;
authenticating the connection request by evaluating whether the first user is listed on the list of users;
in response to authenticating the connection request, generating, on the computing device associated with the first user, a graphical user interface displaying an option for inputting a signature by the first user; and
capturing, via the option displayed by the graphical user interface on the computing device associated with the first user, the signature of the first user indicating signoff on the completion of the first lab procedure.

2. The method of claim 1,
wherein identifying the first lab procedure comprises identifying the first lab procedure for signoff by one authorized user in either the list of users or a second list of users, and
wherein authenticating the connection request comprises evaluating whether the first user is listed on the list of users or the second list of users.

3. The method of claim 1, further comprising:
identifying the first lab procedure for signoff by another authorized user of a second list of users different from the list of users;
receiving a second connection request by a second computing device, the second connection request including login information identifying a second user;
authenticating the second connection request by evaluating whether the second user is listed on the second list of users;
in response to authenticating the second connection request, generating, on the second computing device associated with the second user, a graphical user interface displaying an option for inputting a signature by the second user; and
capturing, via the option displayed by the graphical user interface on the second computing device associated with the second user, the signature of the second user indicating signoff on the completion of the first lab procedure.

4. The method of claim 1, further comprising:
in response to capturing the signature of the first user, transmitting a second notification to the one or more computing devices indicating signoff capture.

5. The method of claim 1, further comprising:
identifying a second lab procedure of the set of lab procedures for signoff by one authorized user of the list of users; and
batching the first lab procedure and the second lab procedure for signoff;
wherein capturing, via the option displayed by the graphical user interface on the computing device associated with the first user, the signature of the first user further indicating signoff on the completion of the second lab procedure.

6. The method of claim 1, wherein authenticating the connection request comprises performing multi-factor authentication.

7. The method of claim 1, wherein generating the graphical user interface comprises generating the graphical user interface to display a status report providing contextual information on the completion of the first lab procedure.

8. The method of claim 7, wherein generating the graphical user interface to display the status report comprises generating the graphical user interface to display images captured by a camera system during performance of the first lab procedure by the robotic lab.

9. The method of claim 1, further comprising:
in response to denying the connection request, disabling signoff functionality in the graphical user interface.

10. The method of claim 1, further comprising:
generating a laboratory log indicating completion of the first lab procedure and the signature of the first user signing off on the completion of the first lab procedure.

11. A non-transitory computer-readable storage medium storing instructions that, when executed by a processor, cause the processor to perform operations comprising:
accessing a set of one or more lab procedures in performance by a robotic lab including one or more robots controlling lab equipment, wherein each lab procedure includes one or more instructions for controlling operation of the one or more robots;
identifying a first lab procedure of the set of lab procedures for signoff by one authorized user of a list of users;
transmitting a notification to one or more computing devices indicating completion of the first lab procedure and prompting signoff of the first lab procedure;
receiving a connection request by a computing device, the connection request including login information identifying a first user;
authenticating the connection request by evaluating whether the first user is listed on the list of users;
in response to authenticating the connection request, generating, on the computing device associated with the first user, a graphical user interface displaying an option for inputting a signature by the first user; and
capturing, via the option displayed by the graphical user interface on the computing device associated with the first user, the signature of the first user indicating signoff on the completion of the first lab procedure.

12. The non-transitory computer-readable storage medium of claim 11,
wherein identifying the first lab procedure comprises identifying the first lab procedure for signoff by one authorized user in either the list of users or a second list of users, and
wherein authenticating the connection request comprises evaluating whether the first user is listed on the list of users or the second list of users.

13. The non-transitory computer-readable storage medium of claim 11, the operations further comprising:
identifying the first lab procedure for signoff by another authorized user of a second list of users different from the list of users;
receiving a second connection request by a second computing device, the second connection request including login information identifying a second user;
authenticating the second connection request by evaluating whether the second user is listed on the second list of users;
in response to authenticating the second connection request, generating, on the second computing device associated with the second user, a graphical user interface displaying an option for inputting a signature by the second user; and
capturing, via the option displayed by the graphical user interface on the second computing device associated with the second user, the signature of the second user indicating signoff on the completion of the first lab procedure.

14. The non-transitory computer-readable storage medium of claim 11, the operations further comprising:
in response to capturing the signature of the first user, transmitting a second notification to the one or more computing devices indicating signoff capture.

15. The non-transitory computer-readable storage medium of claim 11, the operations further comprising:
identifying a second lab procedure of the set of lab procedures for signoff by one authorized user of the list of users; and
batching the first lab procedure and the second lab procedure for signoff;
wherein capturing, via the option displayed by the graphical user interface on the computing device associated with the first user, the signature of the first user further indicating signoff on the completion of the second lab procedure.

16. The non-transitory computer-readable storage medium of claim 11, wherein authenticating the connection request comprises performing multi-factor authentication.

17. The non-transitory computer-readable storage medium of claim 11, wherein generating the graphical user interface comprises generating the graphical user interface to display a status report providing contextual information on the completion of the first lab procedure.

18. The non-transitory computer-readable storage medium of claim 17, wherein generating the graphical user interface to display the status report comprises generating the graphical user interface to display images captured by a camera system during performance of the first lab procedure by the robotic lab.

19. The non-transitory computer-readable storage medium of claim 11, the operations further comprising:
in response to denying the connection request, disabling signoff functionality in the graphical user interface.

20. The non-transitory computer-readable storage medium of claim 11, the operations further comprising:
generating a laboratory log indicating completion of the first lab procedure and the signature of the first user signing off on the completion of the first lab procedure.
